(19) United States
(12) Patent Application Publication
(10) Pub. No.: US 2002/0008391 A1
(43) Pub. Date: Jan. 24, 2002

(54) Locking system for movable elements such as doors and drawers mounted in a cabinet frame

(76) Inventor: Robert Ernest Patton, Cathedral City, CA (US)

Correspondence Address: ROBERT E. PATTON, 30700 AVENIDA DEL PADRE, CATHEDRAL CITY, CA, 92234, US

(21) Appl. No.: 09/905,728

(22) Filed: Jul. 13, 2001

Related U.S. Application Data
(60) Provisional application No. 60/220,352, filed on Jul. 24, 2000.

(51) Int. Cl. E05B 15/02

(52) U.S. Cl. 292/341.17

(57) ABSTRACT

A latching system for locking in the closed position movable elements such as doors and drawers mounted in cabinet frames for movement between open and closed positions in which a latch element is attached to the cabinet frame and is provided with a cantilevered portion having an aperture therein which engages a pin in the movable element to releasably lock the movable element in the closed position against randomly applied forces such as earthquake generated forces and the like.

### RELATED APPLICATION

This application is based on and claims priority with respect to provisional patent application No. 60/220,352, filed Jul. 24, 2000 for HOUSEHOLD CABINET SAFETY LATCH in the name of Robert Ernest Patton. Priority is further claimed based on Disclosure Document number 477414 filed Jul. 24, 2000.

### FIELD OF THE INVENTION

The present invention relates to locking systems for movable elements mounted in cabinet frames and movable between open and closed positions such as cabinet doors and drawers and, more particularly, to locking systems of the aforementioned type that are capable of automatically locking cabinet doors and drawers and the like upon the closing thereof against earthquake type disturbances and randomly applied opening forces.

### BACKGROUND OF THE INVENTION

Today's mass-produced cabinets, such as wall cabinets used in typical household kitchens for example, are not usually provided with locking devices to hold the doors and drawers thereof in the closed position against randomly applied forces such as may result from earthquake disturbances or against attempts by children to gain access thereto. Locking systems for such applications are available in the prior art but these are complicated, expensive, generally cumbersome to install and operate and are typically not aesthetically pleasing.

### SUMMARY OF THE INVENTION

The present invention provides a simple and inexpensive locking system that operates automatically upon closing to lock cabinet doors and drawers in the closed position, that is easy to install and operate and that has a low visual impact on the overall appearance of such installations. The locking system of the present invention operates as a positive latch and is earthquake resistant because of its positive action in locking. It is also resistant to random opening forces such as may be applied by small children, for example.

The locking system of the present invention operates automatically upon the closing of the door and/or drawer elements against the cabinet frame to lock the door and/or drawer elements in the closed position. The locking function that is automatically activated by the closing action is capable of being readily released by a simple hand and finger movement to release the locking action thereof and permit easy opening of the latched door and/or drawer elements

### BRIEF DESCRIPTION OF THE DRAWINGS

FIG. 1 is a cross sectional side view of one embodiment of the present invention as installed on cabinet door and frame elements shown in the open position and at the point of first contact between the locking elements as the door moves to the closed position;

FIG. 2 is another cross sectional side view of the embodiment of FIG. 1 showing the elements in the closed position.

FIG. 3 is a perspective view of one of the latch elements of the embodiment of FIG. 1;

FIG. 4 is another perspective view of the latch element of FIGS. 1 and 2;

FIG. 5 is a cross sectional side view of the latch element shown in FIGS. 3 and 4; and

FIG. 6 is cross sectional view of the embodiment of FIGS. 1 and 2 showing the engagement of the elements of the locking system when the cabinet door is moved toward the open position when the locking system is in the locked condition.

### DETAILED DESCRIPTION OF THE INVENTION

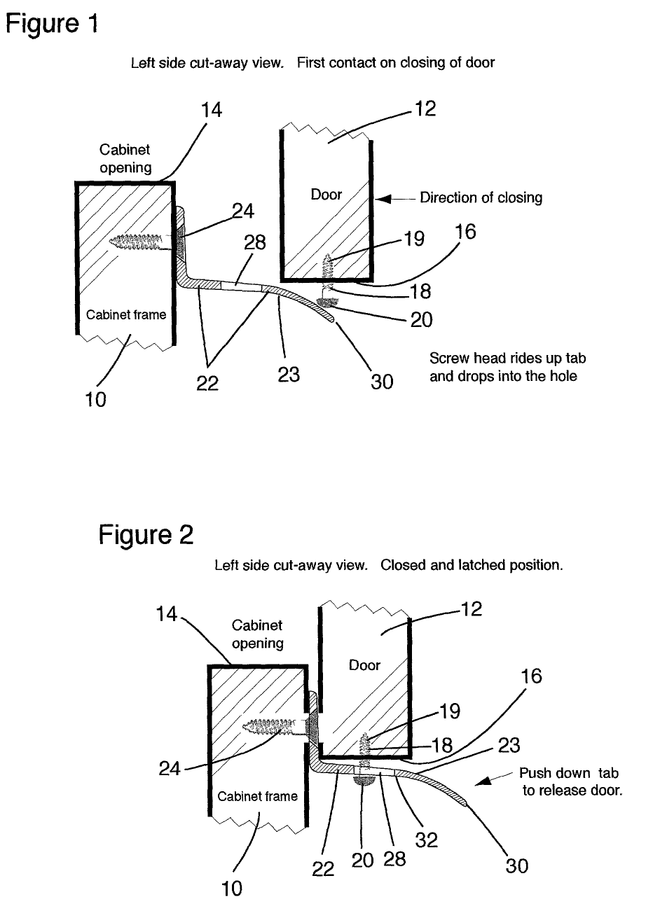

Referring now to the embodiment of FIGS. 1 and 2, there is shown in cross sectional format a cabinet frame 10 and a movable element in the form of a cabinet door 12. The door 12 is hinged to the frame 10 in the usual and well-known manner (not shown) and is shown in FIG. 1 the open position with the door 12 spaced away from the frame 10. The door 12 is moved to the left toward the frame 10 for closing. The closed position is shown in FIG. 2.

In the embodiment shown in FIGS. 1 and 2, the lower surface of a cabinet opening is defined by a surface 14 of the frame 10. The door 12 has a lower surface 16 on which is mounted a pin element 18, shown in FIGS. 1 and 2 in the form of a screw with a body portion 19 and a head portion 20. The pin 18 extends from the lower surface of the door 12 so that the head portion 20 is spaced away from the lower surface 16.

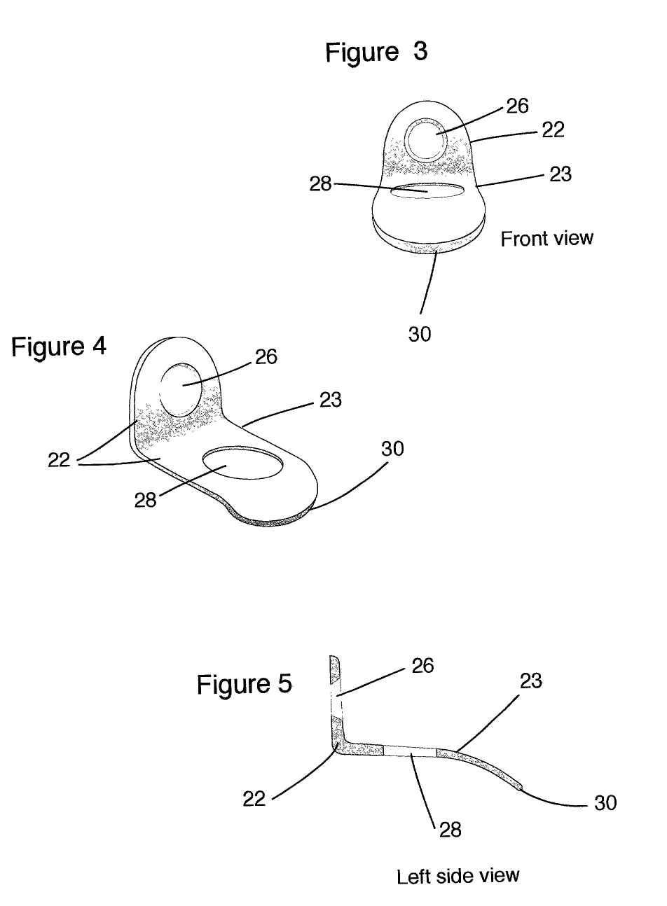

A first latch element 22 is attached to the frame 10 by means of a flat head mounting screw 24. The latch element 22 is shown in further detail in FIGS. 3, 4 and 5. Referring to FIGS. 3, 4 and 5, latch element 22 is provided with a countersunk hole 26 for receiving the mounting screw 24 so that when secured in position, the face of the flat head of the mounting screw 24 is flat against the surface of the latch element 22.

The latch element also includes an extending cantilevered portion 23 with an aperture 28 for capturing the pin element 18 as will be explained below in connection with the further description of the embodiment of FIGS. 1 and 2. The latch element also includes a resilient inclined tab 30 portion which is engaged by the head portion 20 of the pin 18 during closing as will be explained below.

Referring now to FIG. 1, as the door is moved to the left toward the closed position, the head portion 20 of the pin 18 contacts the upper surface of the resilient inclined tab 30. The point of first contact between the head portion 20 and the inclined tab portion 30 is shown in FIG. 1. As the door continues to move to the left from the position shown in FIG. 1 toward the closed position, the head portion 20 further depresses the resilient inclined tab portion 30 and rides up the upper surface thereof to reach the closed position shown in FIG. 2 with the head portion 20 snapping into the locked position in aperture 28 as shown in FIG. 2.

The locking system elements are positioned relative to each other such that with the elements in the closed position as shown in FIG. 2, the pin 18 extends below the surface of the aperture 28 so that the pin 18 is captured in the aperture 28. In this position, outward movement of the door 12 is limited by the engagement of the pin 18 with the surface of the aperture 28. In the preferred embodiment as shown, the head 20 assists and makes more secure the capture of the pin 18 within the aperture 28 by engaging the under surface of the inclined tab portion 30 at the aperture 28 upon outward movement of the door 12 to thereby further prevent the escape of the pin from the aperture 28.

The locking system of the embodiment of FIGS. 1 and 2 therefore provides for automatic locking of the system in the closed position through the movement of the door 12 into the closed position. As the head portion 20 of the pin 18 rides over the surface of the resilient inclined tab portion 30, it snaps into the locked position shown in FIG. 2 when the head portion 20 reaches the aperture 28 and falls into the captured position as shown. That is, the pin 18 moves the inclined tab portion to a fully deflected position and then when the pin 18 registers with the aperture 28, the inclined tab portion snaps from the deflected position into the locked position with the pin captured within the aperture 28.

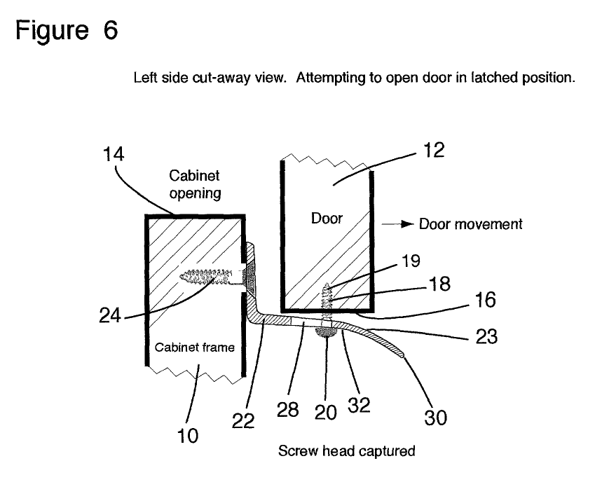

If the door 12 is moved toward the open position with the elements of the system in the locked condition as shown in FIG. 2, the underside of the head portion 20 of the pin 18 will engage the under surface of the aperture 28 as shown in FIG. 6 so that the pin 18 is firmly captured with the edge of the head portion under the edge of the aperture 28 and held against escape from the aperture in a direction parallel to the axis of the pin 18.

The latch element 22 is preferably formed in a single piece entirely of a flexible material, such as a molded plastic material, so that the entire extending portion of the latch element extending outwardly from the frame 10 acts as a flexible cantilever with the inclined tab portion 30 thereof acting as a cam surface for the engagement of the head portion 20 of the pin 18. The term “flexible” as used herein means that the material returns to its original position when released after being deflected, in an amount as described herein for operation of the locking system of the invention, and that the material does not retain a permanent set after release of the deflecting force.

It is understood that the presence of the head portion 20 on the pin 18 represents a preferred embodiment and that the engagement of the pin 18 with the aperture 28 will by itself still function to limit the outward movement of the door 12 from the closed position even without the head portion 20. However, the head portion 20 provides a further degree of locking security as explained above and this embodiment is therefore preferred.

It is to be noted that in the preferred embodiment as presented herein, there are no moving parts other then the flexing of the latch element as the door 12 is moved to the closed position and that the attainment of the locked status is automatic with the closing of the door 12.

The resilient inclined tab portion 30 extends beyond the outer surface of the door 12 in the locked position as shown in FIG. 2 so that it is accessible for manual downward deflection and release. Release of the system from the locked position is realized by pressing down with a simple finger movement to downwardly deflect the extending portion of the resilient inclined tab portion 30 and thereby release the pin 18 and its head portion 20 from the aperture 28, permitting outward movement of the door 12.

The locking system of the invention may be mounted at any point on the frame 10 and the door 12 so long as the elements are aligned to interact with each other upon closing. In many cases, the bottom edges of the door 12 will be preferred both from the standpoint of appearance and also from the standpoint of ease of access for release.

The locking system of the invention can also be mounted on drawers to interact between the drawers and the frame in which they are mounted to lock the drawers in the closed position. In such an application, the cabinet frame would be represented by the element 10 and the drawer would be represented by the element 12 so that the locking system of the invention will function in the same manner as the embodiment presented herein. The system is generally applicable to the locking of movable elements such as drawers or doors mounted in a cabinet frame and movable between open and closed positions in the frame.

It is understood that the pin 18 with the body portion 19 and the head portion 20 can be in a form other than the screw element shown in the embodiment of FIGS. 1 and 2 although the screw element, which forms both the pin 18 and the head portion 20, represents a simple and inexpensive option and is easy to attach to the door or drawer element 12. The aperture 28 in the latch element 22 may also take different forms and still function in the manner presented herein.

The term “pin” as used herein means any form of protrusion or extension capable of registering within the aperture 28 and being restrained therein to prevent movement from the closed position. Similarly, the term “aperture” as used herein means any form of depression or opening capable of receiving the pin on the movable element to capture the same and prevent movement from the closed position.

Although the term “pin” is thus defined, in the preferred embodiment the diameter or width of the head portion 20 must be greater than the diameter or width of the body portion 19 of the pin and the diameter or width of the aperture 28 must be slightly greater than the diameter or width of the head portion 20 in order to allow the head portion to enter the aperture. This relationship of the diameters or widths of these elements allows the head portion 20 to engage the underside of the aperture 28 when the body portion 19 of the pin 18 is up against the edge of the aperture 28 restraining lateral movement of the door 12, thereby preventing extraction of the pin 18 from the aperture in the direction parallel to the axis of the pin. It is also preferable in this embodiment that the under surface of the head portion 20 be flat and substantially perpendicular to the axis of the pin body portion 19 so that this flat surface engages the underside 32 of the edge of the aperture 28 in a manner firmly holding the pin 18 within the aperture 28 when the door 12 is moved toward the open position. This can be observed in FIG. 2 wherein it can be seen that the flat underside of the screw head portion 20 will engage the underside 32 of the edge of the aperture 28 when the door 12 is moved to the right toward the open position. The head portion 20 of the pin 18 is thus captured under the edge of the aperture 28 when the door 12 is moved toward the open position, thereby preventing the extraction of the pin 18 from the aperture 28.

Various modifications and applications of the invention will occur to those skilled in the art. It is therefore to be understood that the scope of the invention is not limited to the preferred embodiment which is presented herein for purposes of full disclosure thereof and not by way of limitation of scope.

What is claimed is:

1. A locking system for locking in the closed position a movable element such as a door or a drawer mounted for movement between open and closed positions in a cabinet frame comprising:
(a) a latch element attached to said cabinet frame, said latch element having a cantilevered portion extending from said frame;
(b) said cantilevered portion having an aperture therein and including an inclined tab portion extending outwardly from said aperture;
(c) a pin mounted on said movable element and positioned to engage and move said inclined tab portion to a deflected position upon movement of said movable element toward the closed position in said cabinet frame
(d) said aperture in said cantilevered portion being positioned to engage said pin and release said inclined tab portion from said deflected position when said movable element reaches the closed position, thereby capturing said pin in said aperture and locking said movable element in the closed position.

2. A locking system as set forth in claim 1 wherein said pin includes a body portion and a head portion, said head portion being positioned to engage said inclined tab portion and to extend into said aperture when said movable element is in the locked position to further secure said pin against movement out of said aperture.

3. A locking system as set forth in claim 2 wherein said pin is in the form of a screw and said head portion is formed by the head of said screw.

4. A locking system as set forth in claim 1 wherein said latch element is formed of a single piece of resilient molded plastic material.

5. A locking system as set forth in claim 2 wherein said head portion of said pin is wider than said body portion and wherein said head portion engages the underside of the edge of said aperture when movable element is moved toward the open position, thereby preventing extraction of said pin from said aperture.

6. A locking system as set forth in claim 5 wherein said head portion includes an under surface which is substantially flat and which is substantially perpendicular to the axis of said pin.
